(19) United States
(12) Patent Application Publication
(10) Pub. No.: US 2012/0088140 A1
(43) Pub. Date: Apr. 12, 2012

(54) BATTERY HAVING INTERNAL ELECTROLYTE FLOW PATH AND/OR INTEGRAL HEAT SINK

(76) Inventors: Grzegorz M. Kardasz, Richmond Hill (CA); Barbara Anna Kardasz, Richmond Hill (CA); Seungwoo Chu, Hwaseong-si Gyeonggi-do (KR); David Mark Pascoe, Aurora (CA); Jean-Yves St.Gelais, Stouffville (CA); Soeren Striepe, Mt. Albert (CA)

(21) Appl. No.: 13/269,029

(22) Filed: Oct. 7, 2011

Related U.S. Application Data
(60) Provisional application No. 61/391,326, filed on Oct. 8, 2010.

(51) Int. Cl. H01M 2/02; H01M 10/50

(52) U.S. Cl. 429/120; 429/163

(57) ABSTRACT

In one aspect, a battery is provided having at least one cathode sheet formed from a metallic foil electrode coated with an active material and at least one anode sheet formed from a metallic foil electrode coated with an active material. The anode sheet is disposed in overlying relationship with the cathode sheet so as to provide at least one cathode/anode electrode pair. The battery further includes a separator between the cathode and anode sheets, electrolyte, and a packaging encasing the at least one cathode and anode sheets and containing the electrolyte. The active material on the cathode sheet(s) is formed to have ridges and depressions therein enabling the electrolyte to flow and wet the electrode(s).

### FIELD OF THE INVENTION

The invention relates to the construction of batteries.

### BACKGROUND OF THE INVENTION

Prismatic batteries are known that utilize flexible sheets for constructing anode/cathode pairs. A number of cathode/anode pairs may be stacked in parallel to create a battery cell. As the battery capacity increases, the size of the stack must increase, and thus the number of cathode/anode pairs employed and/or the physical area of the sheets is increased to provide greater energy storage capacity. However, this leads to performance issues such as heat entrapment and other manufacturing issues which the present invention seeks to ameliorate.

### SUMMARY OF THE INVENTION

According to one aspect of the invention a battery is provided having at least one cathode sheet formed from a metallic foil electrode coated with an active material; at least one anode sheet formed from a metallic foil electrode coated with an active material, the anode sheet being disposed in overlying relationship with the cathode sheet so as to provide at least one cathode/anode electrode pair; a separator between the cathode and anode sheets, electrolyte; and a packaging encasing the at least one cathode and anode sheets and containing the electrolyte. The active material on the cathode sheet(s) is formed to have ridges and depressions therein enabling the electrolyte to flow and wet the electrode(s).

The battery may be a “jelly roll” type battery where the cathode and anode sheets are rolled together. Or, the battery may be a prismatic battery having cathode sheets with anode sheets interleaved between the cathode sheets so as to provide a stacked arrangement of cathode/anode electrode pairs with the separator being interleaved between the cathode and anode sheets.

In either construction, the active material for the anode sheets is preferably formed to also have ridges and depressions therein for enabling the electrolyte to wet the electrode.

The metallic foil forming each of the anode and cathode sheets has first and second faces that are both coated with an active material. The ridges and depressions in the active material may be formed by calendaring the coated metallic foil in order to compress various regions of the coating more than other regions, by ablating the coating in various regions, or by screening the coating via a mask onto certain regions of the foil but not other regions.

According to another aspect of the invention, a prismatic battery is provided having a first stack of cathode/anode pairs and a second stack of cathode/anode pairs. Each cathode/anode pair is formed from a flexible cathode sheet, a flexible anode sheet overlapping and co-extensive with the cathode sheet, and a separator interleaved between the cathode sheet and anode sheet. The battery includes a heat conducting plate having first and second faces, where the first stack abuts the first plate face and the second stack abuts the second plate face. The plate extends past a periphery of the first and second stacks to provide a heat dissipation surface. A rigid casing that houses the first and second stacks is also in thermal contact with the plate.

Preferably, a periphery of the casing incorporates a tubular structure for directing the flow of cooling medium and the plate projects into the tubular structure. The casing may be composed of two clam shell halves, each clam shell half having a half-cylinder formed at a periphery thereof.

In addition, the battery preferably includes a male snap fit terminal electrically connected to the first stack and a female snap fit terminal electrically connected to the second stack, where the male and female snap fit connectors projecting from the casing on opposing sides of the plate.

### BRIEF DESCRIPTION OF THE DRAWINGS

The foregoing and other aspects of the invention will be more readily appreciated having reference to the drawings, wherein:

FIGS. 1A and 1B are schematic diagrams of a stack of prismatic cathode/anode pairs known in the prior art;

FIG. 2 is a schematic diagram of a prismatic cathode/anode pair according to an embodiment of the invention where the cathode sheet includes grooves providing a flow path for electrolyte;

FIGS. 3A and 3B are cross sectional and elevational views of press rollers for manufacturing the grooves in the cathode sheets;

FIGS. 4A and 4B are schematic diagrams of a prismatic cathode/anode pair according to another embodiment where cathode and/or anode sheets include grooves providing a flow path for electrolyte;

FIG. 5 is a perspective view of a modular prismatic battery according to a first embodiment;

FIG. 5A is a schematic representation of the modular battery shown in FIG. 5;

FIG. 6 is a cross-sectional view taken along line VI-VI in FIG. 5;

FIG. 7 is a perspective view of a battery module formed from a plurality of the modular prismatic batteries according to the first embodiment;

FIG. 8 is a partial cross-sectional view taken along line VIII-VIII in FIG. 7;

FIG. 9 is a cross-sectional view taken along line IX-IX in FIG. 5;

FIG. 10 is a perspective view of a modular prismatic battery according to a second embodiment;

FIG. 11 is a partial cross-sectional view taken along line XI-XI in FIG. 10;

FIG. 12 is a detail view of region XII as indicated in FIG. 10;

FIG. 13 is an exploded view of a modular prismatic battery according to a third embodiment;

FIG. 14 is perspective view of the third embodiment in assembly;

FIG. 15 is a cross-sectional view taken along line XV-XV in FIG. 14;

FIG. 16 is a detail view of region XVI as indicated in FIG. 14;

FIG. 17 is a detail view of region XVII as indicated in FIG. 14;

FIG. 18 is a partial cross-sectional view taken along line XVIII-XVIII in FIG. 14;

FIGS. 19A and 19B are isolated perspective views of a battery tray employed in the third embodiment;

FIGS. 20A-20D are partial cross-sectional views of alternative forms of radiating fins formed by a bifurcating plate in the battery;

FIGS. 21A and 21B are partial cross-sectional views of alternative forms of radiating fins formed by a battery casing;

FIGS. 22A-22B are schematic views of a modular battery cell according to a variant of the first embodiment; and

FIGS. 23A-23B are schematic views of a modular battery cell according to a second variant of the first embodiment

### DETAILED DESCRIPTION OF PREFERRED EMBODIMENTS

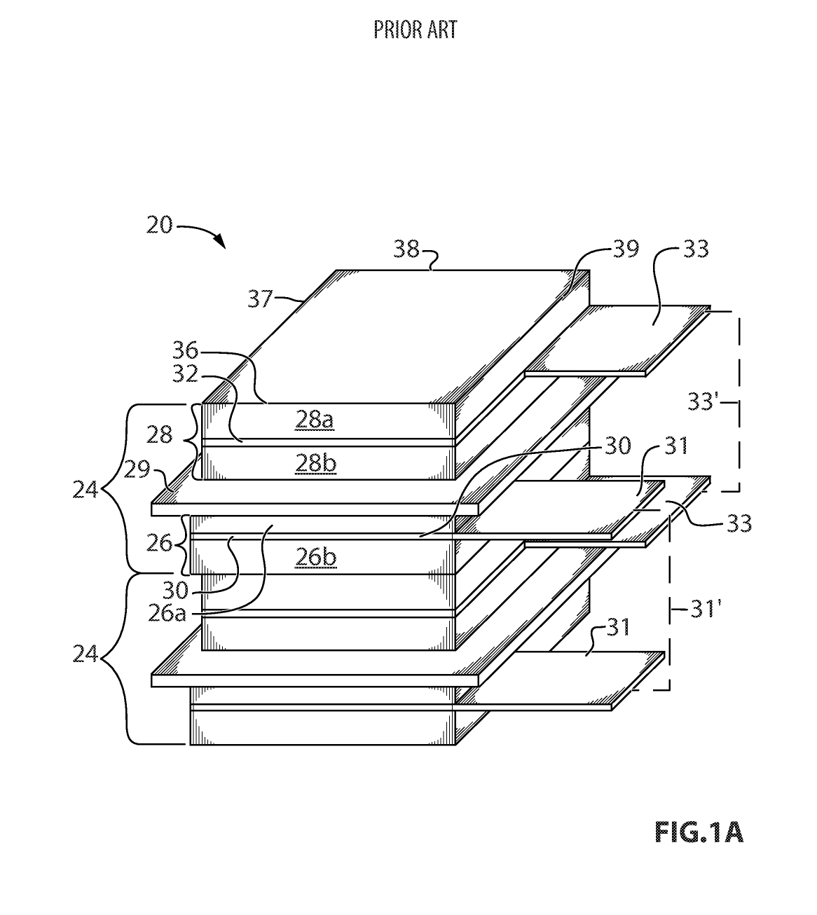

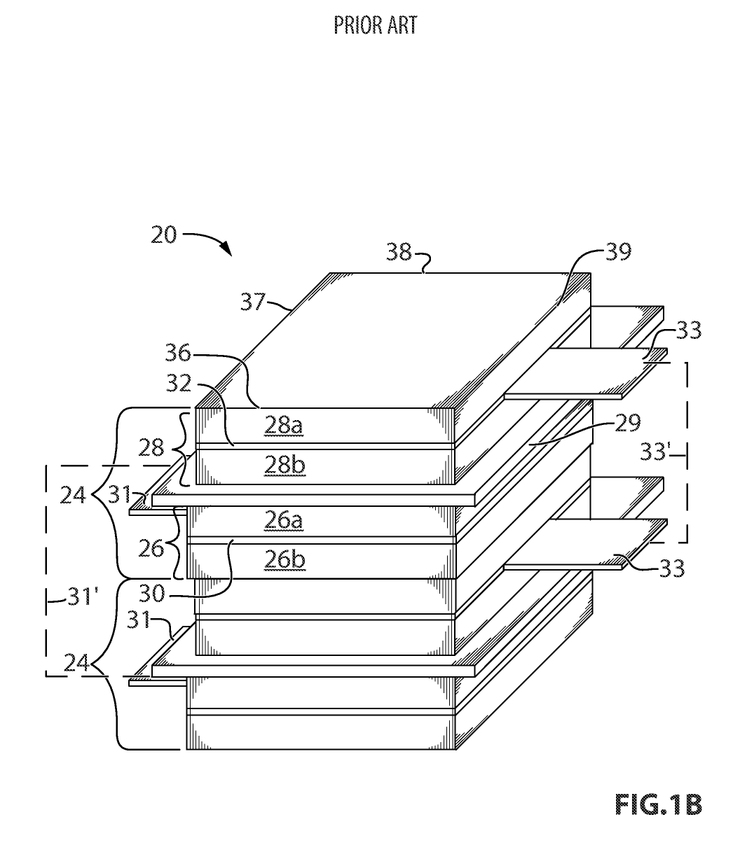

As seen in FIGS. 1A and 1B, a prismatic battery cell is composed of a stack 20 of cathode/anode pairs 24. Each cathode/anode pair 24 includes an anode sheet 26, a cathode sheet 28 in opposing relationship to the anode sheet, and a separator 29 in between the sheets 26, 28. As shown in FIG. 1A or 1B, a prismatic battery cell is formed from a stack 20 of such pairs 24 (in practice, utilizing many such pairs 24) and includes a packaging or casing (not shown in FIGS. 1A, 1B) for containing an electrolyte and protecting the stack 20 from the environment.

In an exemplary cathode/anode pair 24 based on lithium ion chemistry, the anode sheet 26 is preferably formed from two layers 26a, 26b of graphite (such as natural graphite or artificial graphite supplied by Osaka Gas, Japan, or by Timcal, Switzerland,) that sandwich a copper foil electrode 30. (Other anode materials may also be employed such as non-graphitizing carbon, metal composite oxides such as LixFe2O3 (0≦x≦1), LixWO2 (0≦x≦1) and SnxMe1-xMe′yOz (Me: Mn, Fe, Pb or Ge; Me′: Al, B, P, Si, Group I, Group II, and Group III elements of the Periodic Table of the Elements, or halogens; 0≦x≦1; 1≦y≦3; and 1≦z≦8); lithium metals; lithium alloys; silicon-based alloys; tin-based alloys; metal oxides, such as SnO, SnO2, PbO, PbO2, Pb2O3, Pb3O4, Sb2O3, Sb2O4, Sb2O5, GeO, GeO2, Bi2O3, Bi2O4, and Bi2O5; conductive polymers such as polyacetylene; Li—Co—Ni based materials; LixFe2O3 and LiTiO₂; and any combination thereof.) The graphite layers 26a, 26b are relatively thin, each having a thickness in the range of about 20-400 μm. The copper foil electrode 30 is also relatively thin, having a thickness in the range of about 8-50 μm.

The cathode sheet 28 is also preferably formed from two layers 28a, 28b of lithium metal oxide (such as LiCoₓMn_{y}Ni_{z}O₂ where x+y+z=1, 0<=x, z<=1, or LiCoO₂, LiMn₂O₄, or LiMnNiAlO₂, or LiMePO₄, where Me═Fe, Mn, FeₓMn_{y} (x+y=1) and any combination thereof) that sandwich an aluminum foil electrode 32. The lithium metal oxide layers 28a, 28b are likewise relatively thin, each having a thickness in the range of about 30-600 μm. The aluminum foil electrode 32 is also relatively thin, having a thickness in the range of about 10-100 μm.

In practice, the anode sheet or cathode sheet may be manufactured by mixing the active materials (i.e., graphite for the anode and lithium metal oxide for the cathode) with a solvent and an adhesive in order to coat the copper or aluminum foil. The adhesive bonds the active material to itself and the foil, and the solvent evaporates as the sheet is heated in a drying oven. After drying, the coated foil is then wound onto a coil. The coil is then subjected to a calendaring process, where the coated foil is passed through press rolls to compress the coating on the top and bottom of the foil. The coated foils are then cut to size in a stamping operation, or slitted winding process.

The separator 29 is an insulating thin film having high ion permeability and mechanical strength. The separator typically has a pore diameter of 0.01 to 10 μm and a thickness of 5 to 300 μm. The separator may be provided by sheets or non-woven fabrics made of an olefin polymer such as polypropylene and/or glass fibers or polyethylene, which have chemical resistance. When a solid electrolyte such as a polymer is employed as the electrolyte, the solid electrolyte may also serve as both the separator and electrolyte.

In the illustrated embodiments the separator 29 is a long film that is continuously interleaved between the anode and cathode sheets 26, 28 of the stack 20 in order to separate these

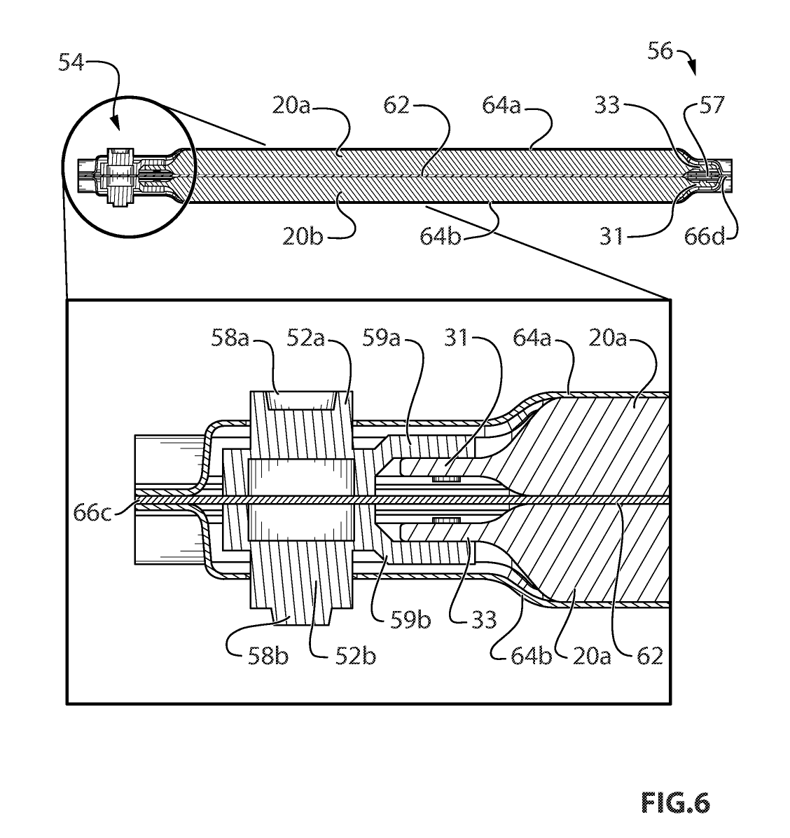

In order to electrically interconnect the anode and cathode sheets 26, 28, the copper foil electrode 30 and aluminum foil electrode 32 are each cut so as to have a projecting tab 31 or 33 extending from the corresponding sheet. The projecting tabs 31 or 33 of each of the cathode/anode pairs 24 in the stack 20 are connected so as to link the cathode/anode pairs 24 in series or in parallel. In the illustrated embodiments of FIGS. 1A and 1B, the anode projecting tabs 31 are coextensive and spaced apart from the likewise coextensive cathode projecting tabs 33. The anode tabs 31 are interconnected to one another (as represented by stippled line 31′) in a parallel arrangement and the cathode tabs 33 are also interconnected to one another in a parallel arrangement (as represented by stippled line 33′). The interconnection may be provided by copper or aluminum rivets (not shown in FIG. 1A or 1B, but see for example FIG. 6, ref no. 53) or by an ultrasonic welding process which mechanically fastens and electrically connects the respective copper or aluminum foil tabs together to produce the stack 20.

FIG. 1A shows an embodiment of the stack 20 where the anode and cathode tabs 31, 33 project from the same side 39 of rectangular-shaped anode and cathode sheets 26 and 28. FIG. 1B shows an embodiment of the stack 20 where the anode and cathode tabs 31, 33 project from opposing sides 37, 39 of the rectangular-shaped anode and cathode sheets 26 and 28. In either case, the separator film 29 is folded around the other sides 36, 38 of the stack as opposed to sides 37, 39 so as to not interfere with the extending tabs 31, 33.

The prismatic battery stack 20 can incorporate many cathode/anode pairs 24. For example, a battery cell may be composed of a stack of fifty cathode/anode pairs 24. To increase power ratings, the size of the prismatic battery stack 20 must be increased. Thus, to increase power ratings, the area of each of the cathode and anode sheets may be increased and/or the number of cathode/anode pairs 24 in the stack 20 may be increased. However, the larger the stack, the more heat is trapped within its center, leading to uneven temperature distribution within the prismatic battery cell. The trapped heat and uneven temperature distribution could have deleterious effects on the performance of the battery cell, including shortened life cycles and increased internal resistances. The larger size also makes it more difficult to wet the cathode and anode sheets with electrolyte, which is typically done in a vacuum chamber after the prismatic battery cell is assembled by removing air from the chamber and injecting electrolyte into the assembled cell.

To deal with the wetting issue, the preferred embodiment as shown in FIG. 2 provides a series of channels 40 on at least the cathode sheet 28. The channels are preferably provided on the upper and lower cathode layers 28a and 28b and thus present open pathways or conduits enabling the electrolyte to penetrate into the center of the cathode sheet 28 and the center of the stack 20. The electrolyte is preferably introduced under vacuum, but because flat sheets are not abutting one another, the electrolyte will flow more readily through the sheets and stack.

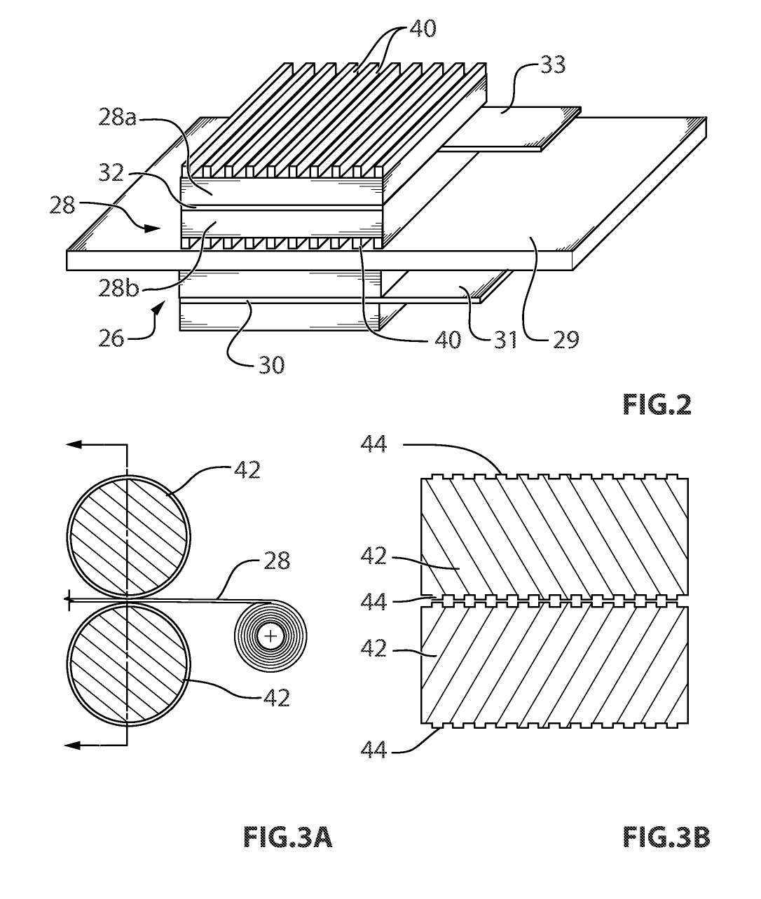

The channels 40 may be provided in the calendaring process where, as schematically indicated in FIGS. 3A and 3B, press rolls 42 have a series of circumferential ridges 44 that provide the impressions for the channels 40. If desired, additional channels (not shown) may also be provided in a direction perpendicular to the illustrated channels 40 to provide a cross-hatching channel pattern or other profile supporting the most effective wetting and degassing. The perpendicular channels may be manufactured by providing a series of axial ridges (not shown) on the press rolls 42 intersecting with the circumferential ridges 44 to thus provide a crosshatched platen applied to the cathode sheet 28. By way of example only, the ridges 44 may have a height of around 2-40 μm, preferentially about 10 μm, and be spaced apart a distance of about 50 μm to 100 mm, preferentially about 200 μm.

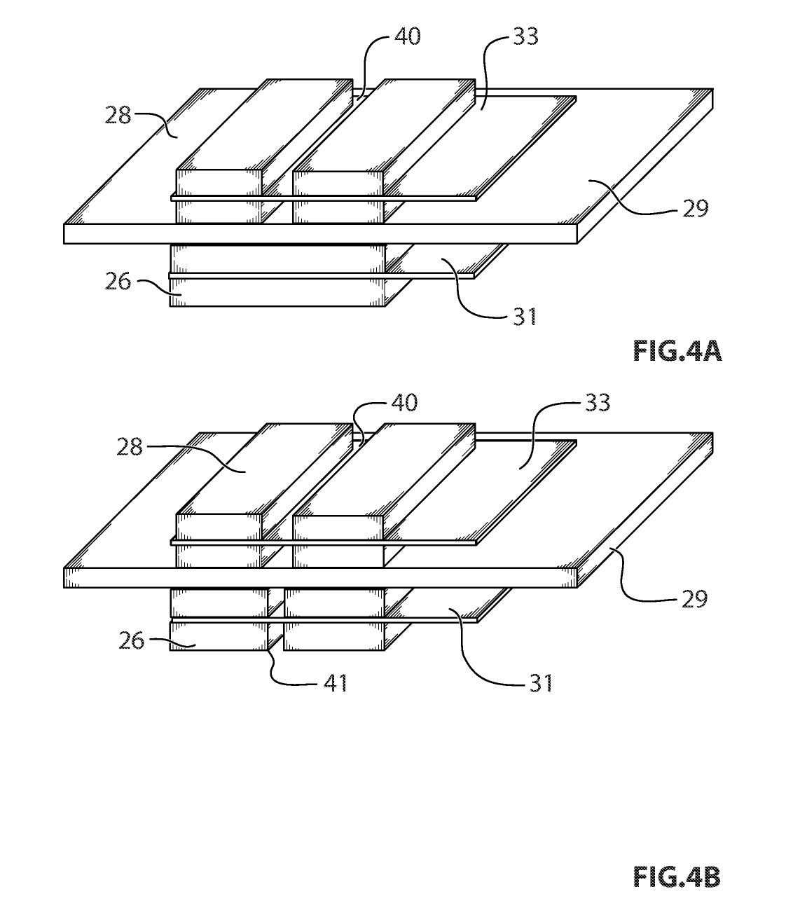

Alternatively, the channels 40 may be provided as part of the coating process, where the coating mixture is screened through a mask so as to deposit the mixture in some areas but not in other areas, such as shown in FIG. 4A. In this embodiment, the aluminum foil 32 is exposed in those areas where the mask is solid and covered where the mask has an aperture. In addition, as shown in FIG. 4B, the mask may also be applied to the anode copper foil 30 so as to provide channels 41 in the upper and lower layers 26a, 26b of anode sheet 26. The cathode channels 40 are preferably wider than the anode channels 41 to prevent lithium plating on the anode surface. A variety of channel patterns may be designed into the mask.

As a further alternative, the channels 40 or 41 may be formed by ablating some of the coating on the foils. For example, a laser may be used to cut or burn a series of channels through the coating. A wide variety of channel patterns may be provided using this method.

The incorporation of one or more of the aforementioned channels is expected to lead to better electrode wetting after the electrode insertion process and result in better cycle life characteristics for the battery compared to the prior art.

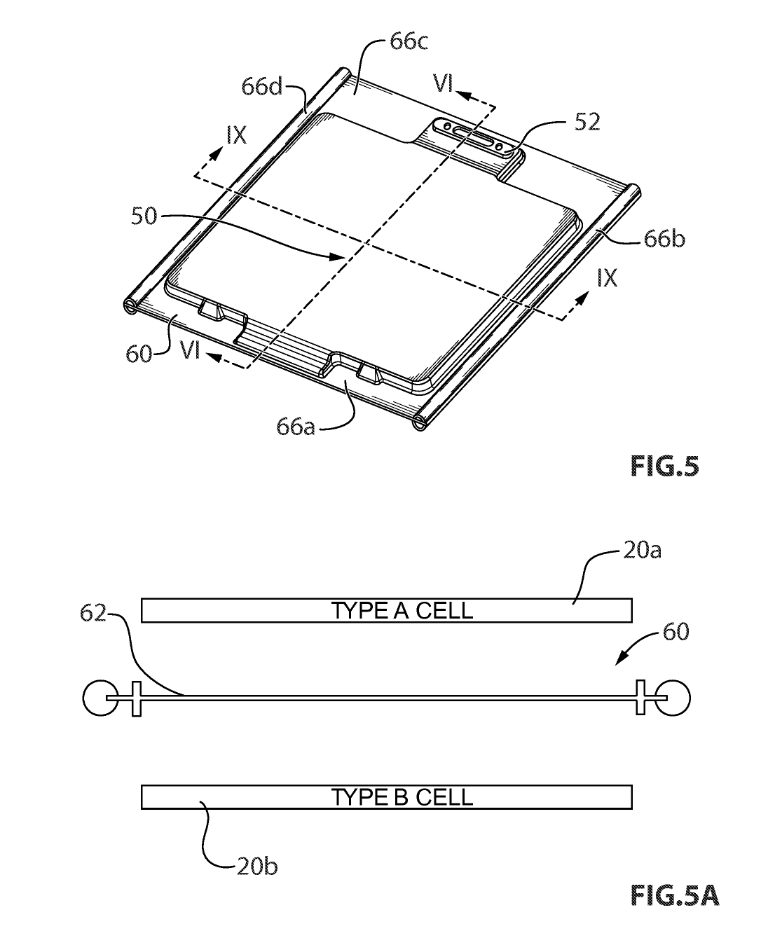

FIG. 5 shows a modular prismatic battery cell 50 that incorporates a snap-fit connector 52 for readily enabling a plurality of the modular cells 50 to be electrically connected together in order to provide a battery module. The modular cell 50 also incorporates an integral heat sink 60 to conduct heat away from its center.

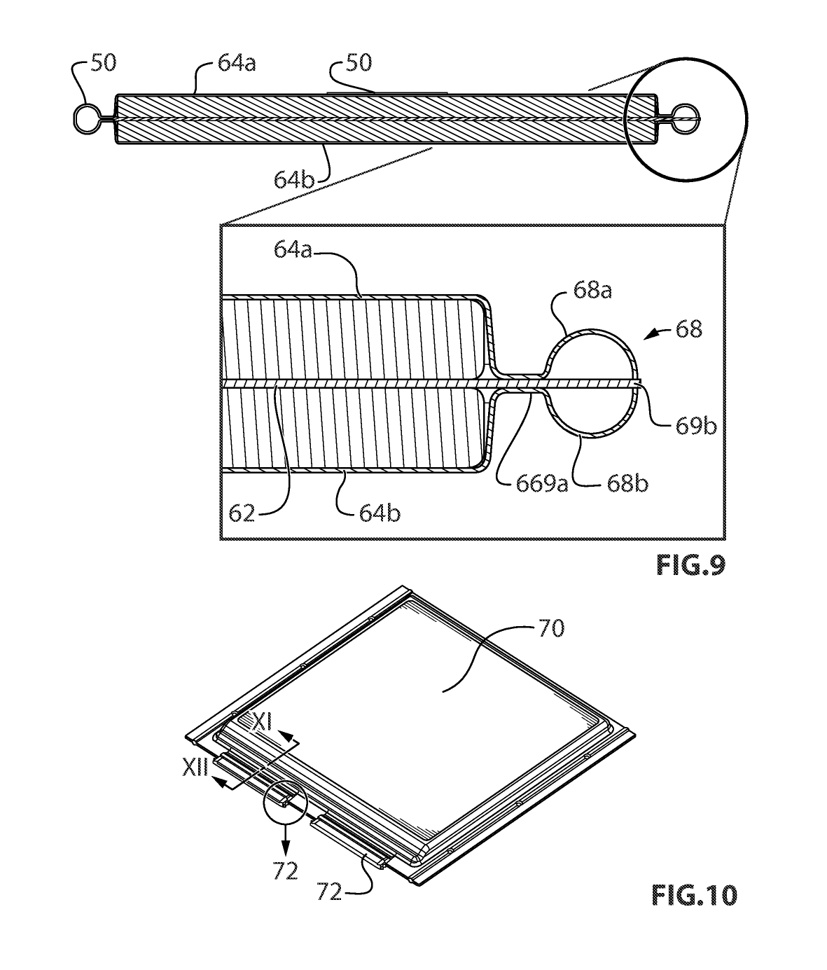

Referring additionally to the cross-sectional view of FIGS. 6 and 9, each modular cell 50 comprises a stack 20 of the interleaved anode and cathode sheets 26, 28 plus interleaved separator 29. The stack 20 is partitioned into two halves 20a and 20b by a heat conductive plate 62 that provides the heat sink. The plate 62 is preferably formed from a material such as aluminum and is coated with a thin non-conductive polymeric film such as polypropylene, polyethylene terephthalate, polyimide or poly-tetrafluoroethylene so that the plate 62 does not electrically contact the stack halves 20a, 20b.

Schematically, as shown in FIG. 5A, the modular cell 50 can be considered to be a combination of a Type A cell, provided by stack half 20a, and a Type B cell, provided by stack half 20b, where the A Type cell and B Type cells are preferably of the same size and separated by the plate 62. The Type A and Type B cells may be interconnected in a serial arrangement or a parallel arrangement, as discussed in greater detail below.

The modular cell 50 preferably utilizes a rigid clam shell casing 64 composed of upper and lower rigid clam shell halves 64a, 64b that may be formed from a variety materials such as plastic or metal. If the clam shell 64 is formed from an electrically conductive material then it also has an insulating liner that may be provided by a plastic film coat. The upper and lower clam shell halves 64a, 64b are preferably seamed to the plate 62 at the periphery 66a, 66b, 66c and 66d of the cell 50 to provide and air and water tight package or casing. In alternative embodiments a less rigid, even flexible, casing may be utilized.

One end 54 of the modular cell 50, referred to as the ‘terminal end’, features the snap-fit connector 52 whereas the opposite end 56 of the modular cell does not have a snap-fit connector. In the embodiment illustrated in FIGS. 5-9, the copper and aluminum foil electrodes are cut so as to have the projecting cathode tabs 31 and anode tabs 33 extending from opposite ends of the respective foils such as shown in FIG. 1B. For series cell connections, stack half 20a (or 20b) has cathode tabs 31 at the terminal end 54 of the modular cell and stack half 20b (or 20a) has anode tabs 33 at the terminal end 54 of the modular cell. At the opposite end 56 of the modular cell 50 stack half 20a (or 20b) has anode tabs 33 and stack half 20b (or 20a) has cathode tabs 31.

At the terminal end 54, the connector 52 is composed of discrete female and male terminals 52a, 52b. The female terminal 52a has a tab portion 59a fastened (e.g., using rivets 53) to the cathode tabs 31 and a connection portion that has well 58a thereon that extends through an aperture in the clam shell 64. Likewise, the male terminal 52b has a tab portion 59b fastened to the cathode tabs 33 and a connection portion that has an embossment 58b thereon that extends out of the clam shell 64. In practice, the female and male terminals are mounted onto the plate 52 and connected to their respective cathode and anode tabs 31, 33 before the upper and lower clam shelve halves 64a, 64b are seamed together. The connectors 52a, 52b are sealed in the area where they protrude through the clam shell halves by applying O-rings or other sealants (not shown.)

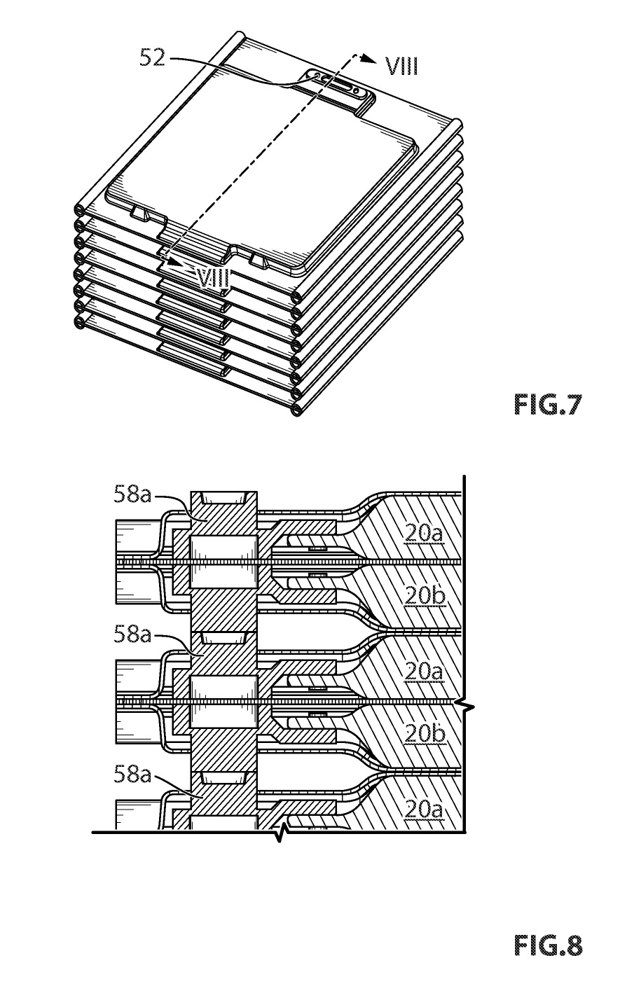

The embossment 58b of the male terminal 52b snap fits into the well 58a of the female terminal 52a to electrically interconnect multiple modular cells 50 as seen in the perspective and partial cross-sectional views of FIGS. 7 and 8.

As seen best in FIG. 6, at the opposite end 56 of the modular cell, the metal plate 62 has an aperture 57 to enable the cathode tabs 33 to be connected to the anode tabs 31, e.g., via rivets. These connections are also formed prior to seaming the upper and lower clam shelve halves 64a, 64b.

As seen best in FIG. 9, at the outer peripheries 66a, 66b of the modular cell 50 the upper and lower clam shell halves 64a, 64b are formed to incorporate half-cylinders 68a, 68b that combine to form a tubular structure 68 bisected by the plate 62. The tubular structure 68 may be sealed at edges 69a, 69b to form a liquid tight channel for the flow of refrigerant therethrough. Alternatively, the sealing may be omitted and the tubular structure 68 utilized for the flow of air therethrough. Irrespective, the plate 62 extends beyond a periphery of the stack halves 20a, 20b so as to provide a heat dissipation surface and thus in alternative embodiments the tubular structure 68 may be omitted.

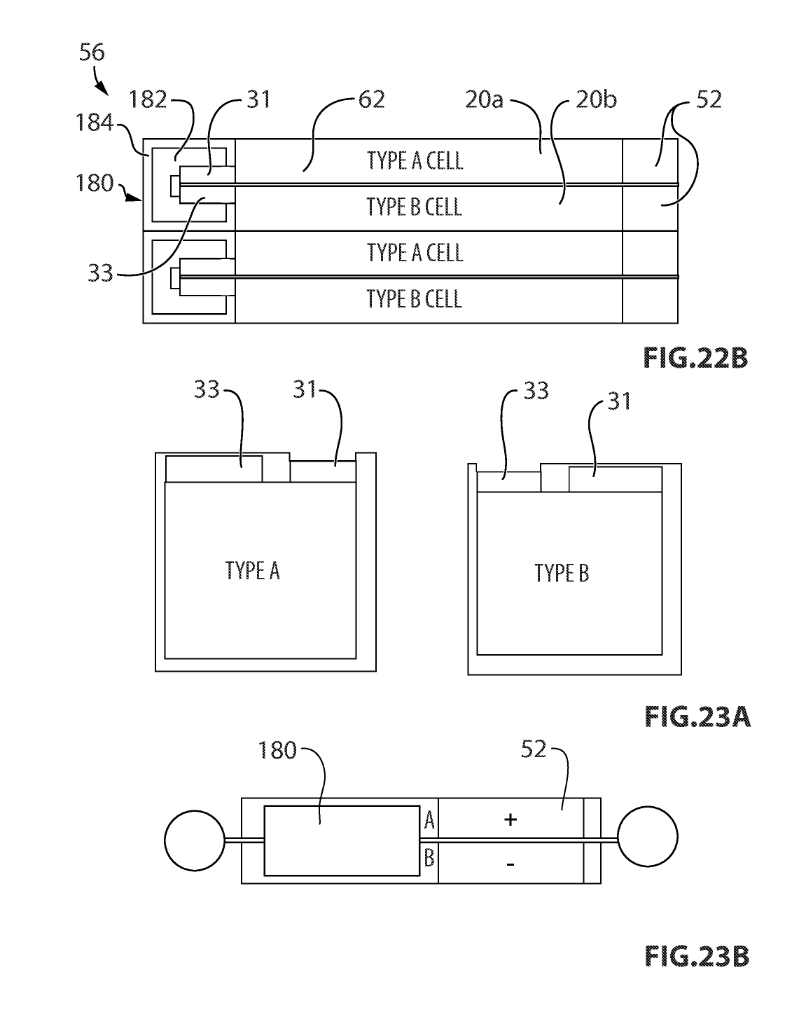

FIGS. 22A-22B show an alternative means for interconnecting the anode and cathode tabs 31, 33 at the opposing end 56 of the modular cell. In this embodiment, the electrode tabs 31 and 33 project from opposing sides of the anode and cathode sheets (as in the geometry of FIG. 1B). However, instead of an internal connection within the casing 64, the tabs 31, 33 extend through an opening in the casing 64 and an external connector 180 mechanically and electrically interconnects the tabs 31, 33 together. As seen in FIG. 22B, the external connector 180 preferably has the same height as the modular cell 50 and includes an electrically conductive C clamp 182 surrounded by an insulating material 184 such as plastic. In the battery module, as shown in FIG. 22B, the external connector 180 can stack together nicely much like the snap-fit connector 52.

Figure is 23A-23B show the use of the electrical connector 180 when the electrode tabs 31 and 33 extend from the same side of the anode and cathode sheets (as in the geometry of FIG. 1A).

A serial connection is employed between the Type A cell and Type B cell in the embodiments of FIGS. 22 and 23. Regardless, it will be appreciated that the Type B cell may be manufactured in exactly the same way as the Type A cell, but simply orientated in a mirror or opposing image relation relative to the Type A cell for assembly into the modular cell 50.

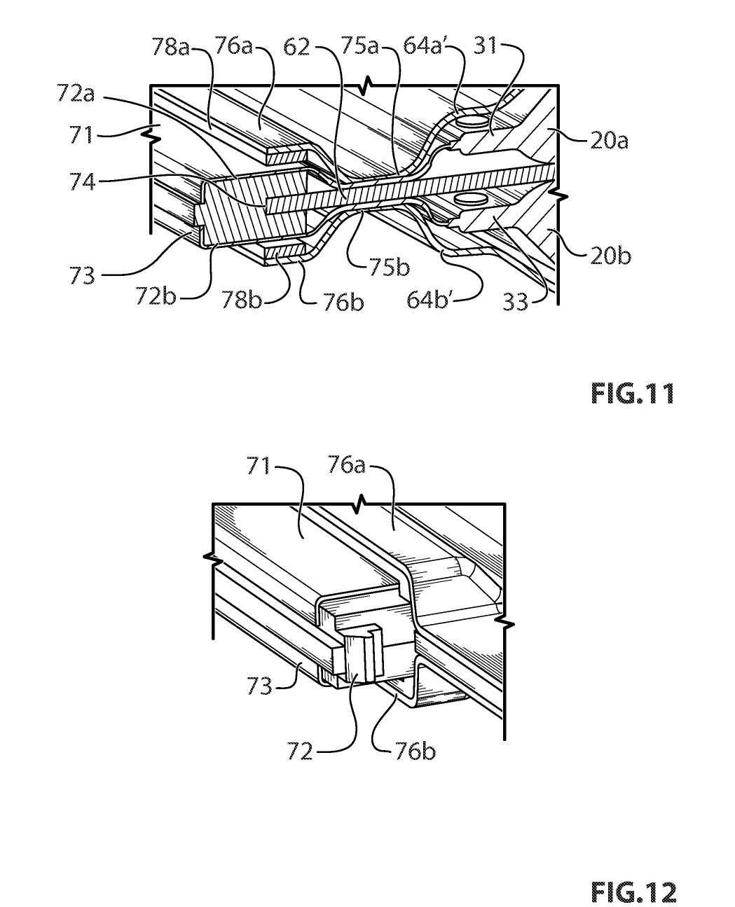

FIGS. 10-12 show another embodiment of a modular battery cell 70 where the cell terminals are supported by snap-in terminal tabs 72. Each terminal tab 72 features a slot 74 for snuggly receiving the metal plate 62. The electrode foil tabs 31 or 33, as the case may be, are connected together by rivets within the clam shell and have a flexible lead 71 or 73 that extends past the periphery of upper and lower clam shell halves 64a′, 64b′ to overlie the top and bottom walls 72a, 72b of the tab 72. The clam shell halves 64a′, 64b′ are seamed together at concavity 75a, 75b and have overhangs 76a, 76b that partially overlie the top and bottom walls 72a, 72b of the terminal tab 72 to clamp the flexible leads 71 or 73 against the terminal tabs 72. Non-conductive spacers 78a, 78b are inserted between the clam shell halves 64a′, 64b′ and the flexible leads 71, 73 to prevent electrical contact with the clam shell casing 64′. The spacers 78a, 78b may be formed from rubber. The terminal tabs 72 are also formed from a non-conductive material, such as rigid plastic.

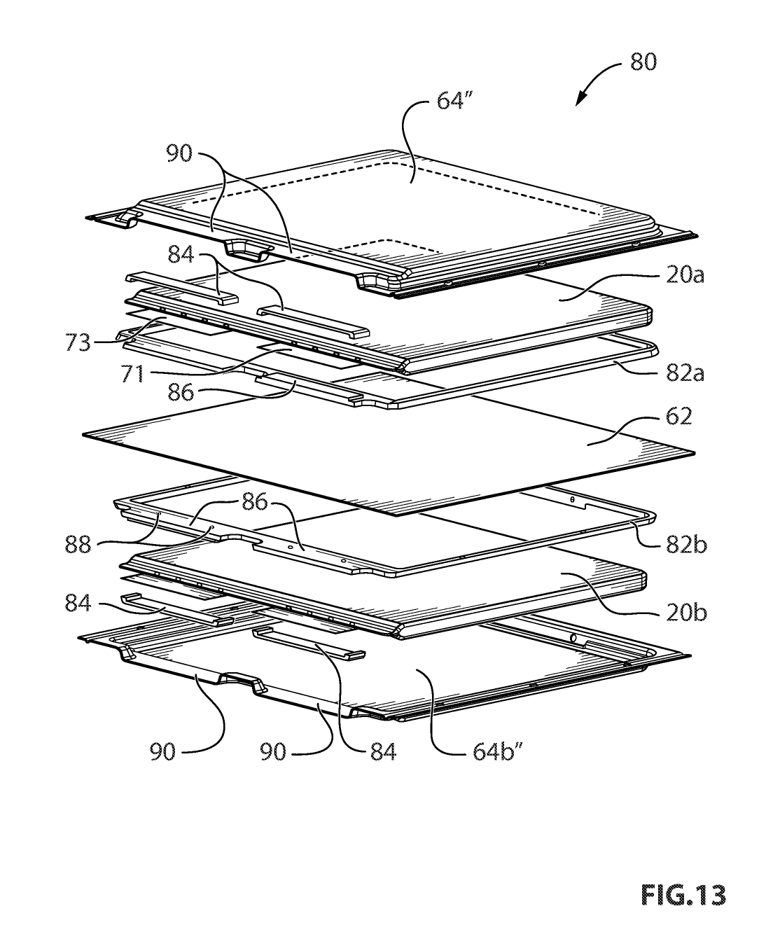

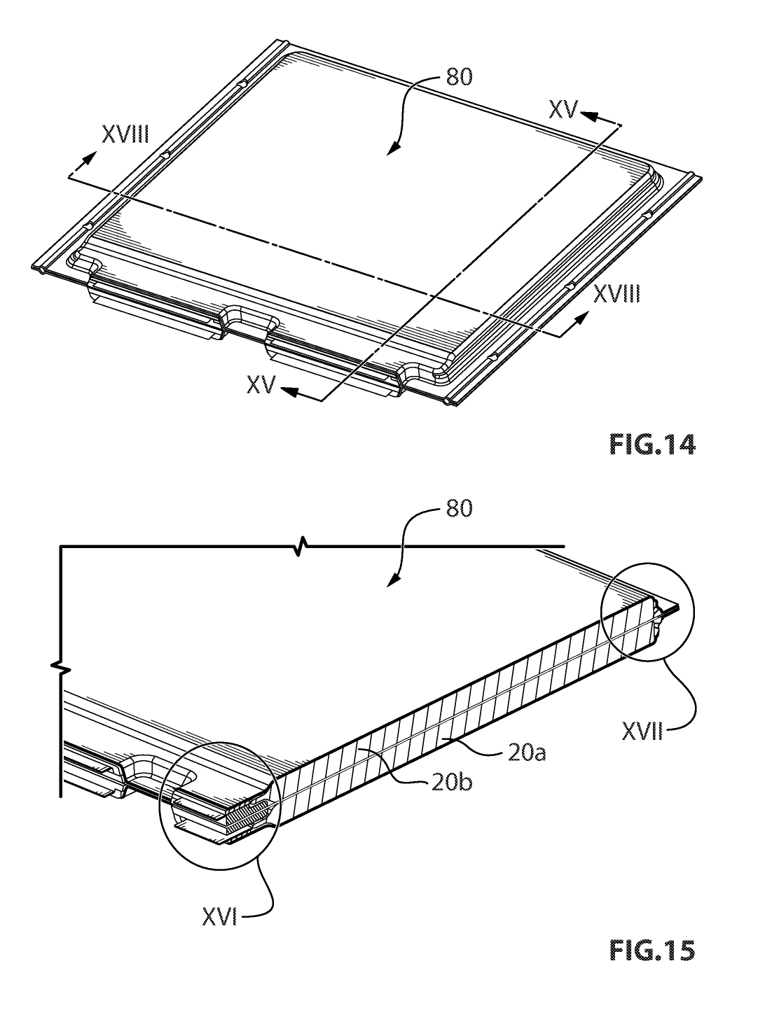

FIGS. 13-19 show another embodiment of a modular battery cell 80 which includes internal trays 82a, 82b used to protect the stack halves 20a, 20b from the clam shell 64 as well as locate terminal protection and seal tabs 84.

More particularly, as seen best in the exploded view of FIG. 13, each internal tray 82a or 82b surrounds the corresponding stack half 20a or 20b thus providing a barrier between the stack halve and the corresponding clam shell half 64a″ or 64b″. The clam shelf halves 64a″ or 64b″ are preferably stamped from sheet metal and thus their dimensions may be not be very accurate. As the stack half 20a, 20b may have sharp edges from its manufacturing process, the internal trays 82a or 82b, which are preferably formed from plastic in an injection moulding process, normalize the space within the clam shell halves and prevent the stack halves from chaffing against the clam shell halves.

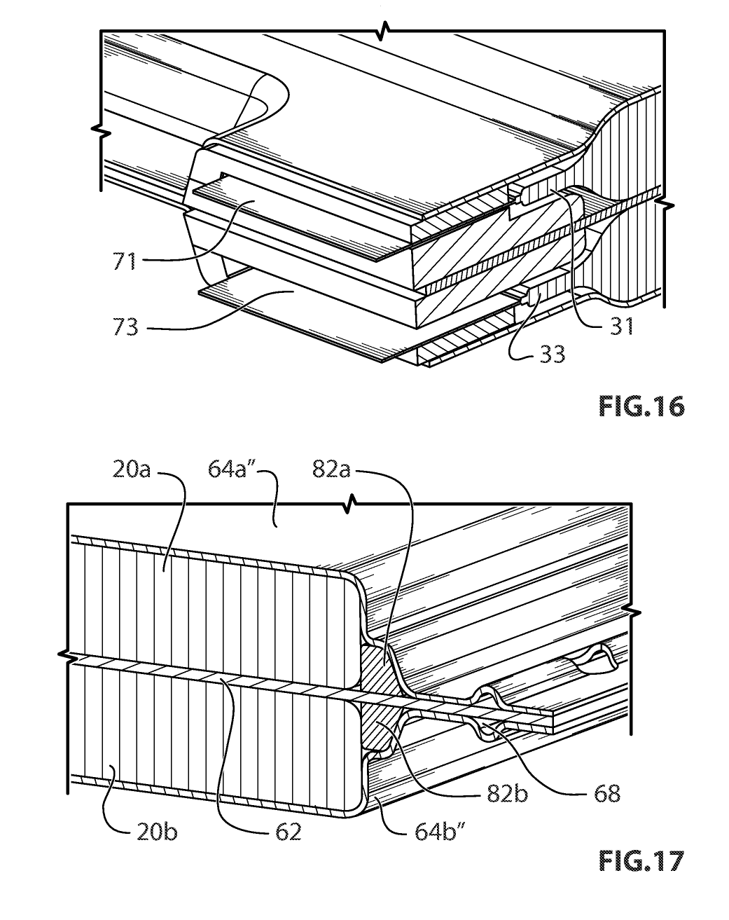

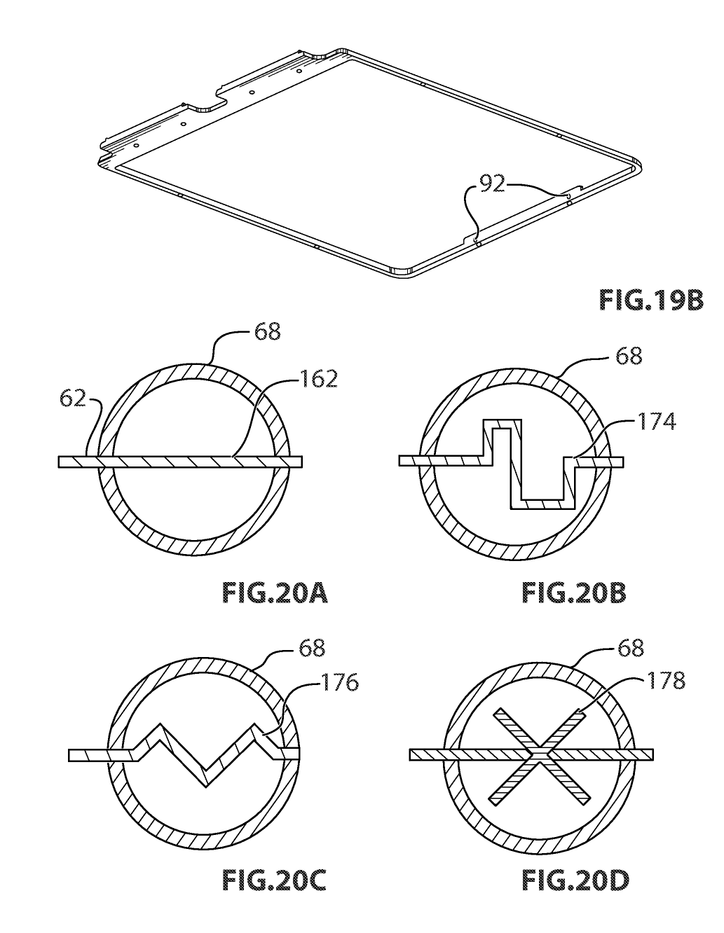

Each internal tray 82a, 82b also includes at least one and preferably two bases 86. These bases 86 have pins 88 (see also FIGS. 19A, 19B) to locate the tray against the underlying heat conducting plate 62. The bases 86 also function to locate the terminal tabs 84. As seen best in the cross-sectional views of FIGS. 15 and 16, the plate 62 extends between and is sandwiched by the bases 86 of the internal trays 82a, 82b. The interconnected electrode foil tabs 31 or 33, as the case may be, are connected to flexible leads 71 or 73 that extend past the periphery of the upper and lower clam shell halves 64a″, 64b″ to overlie the bases 86 on the surfaces opposite the surfaces contacting the metal plate 62. The snap-in terminal tabs 84 are positioned over the flexible leads 71 or 73. The clam shell halves 64a″, 64b″ have overhangs 90 that substantially cover and clamp the terminal tabs 84 against the bases 86, sandwiching the flexible leads 71 or 73 therebetween. The terminal tabs 84 are preferably formed from a non-conductive material to prevent electrical contact with the clam shell halves. The terminal tabs 84 and bases 86 may be adhesively bonded to the clam shell halves 64a″ or 64b″ and plate 62, respectively, as well as the flexible leads 71 or 73, to seal the cell 80.

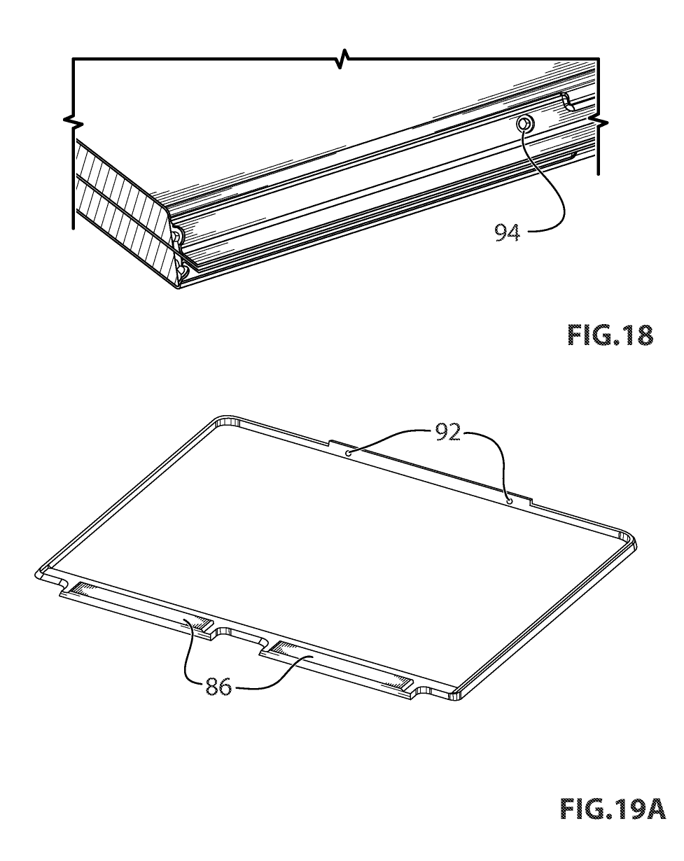

As seen best in FIGS. 19A & 19B the internal trays 82a, 82b includes holes 92 that register with holes 94 located in the clam shell halves, as seen best in FIG. 18. These holes 92, 94 enable electrolyte to be injected under vacuum into an assembled cell 80, and thereafter may be plugged to seal the cell. The internal trays 82a, 82b also function to minimize the quantity of electrolyte required by occupying space between the stack halves 20a, 20b and the outer edges of the clam shell halves 64a″, 64b″ which are seamed together to provide the tubular structure 68 bisected by plate 62, as seen best in FIG. 17.

In the foregoing and other embodiments the plate 62 may be modified at its periphery to introduce cooling fins and thus increase the radiating surface area without increasing the overall breadth of the design. For example, in the embodiment of FIG. 9, shown also at FIG. 20A, the portion 162 of the plate 62 encircled by the tubular structure 68 formed by the upper and lower clam shell halves is flat. However, this portion 162 of the plate may be corrugated as shown in FIGS. 20B, 20C or 20C to provide cooling fins 174, 176 or 178.

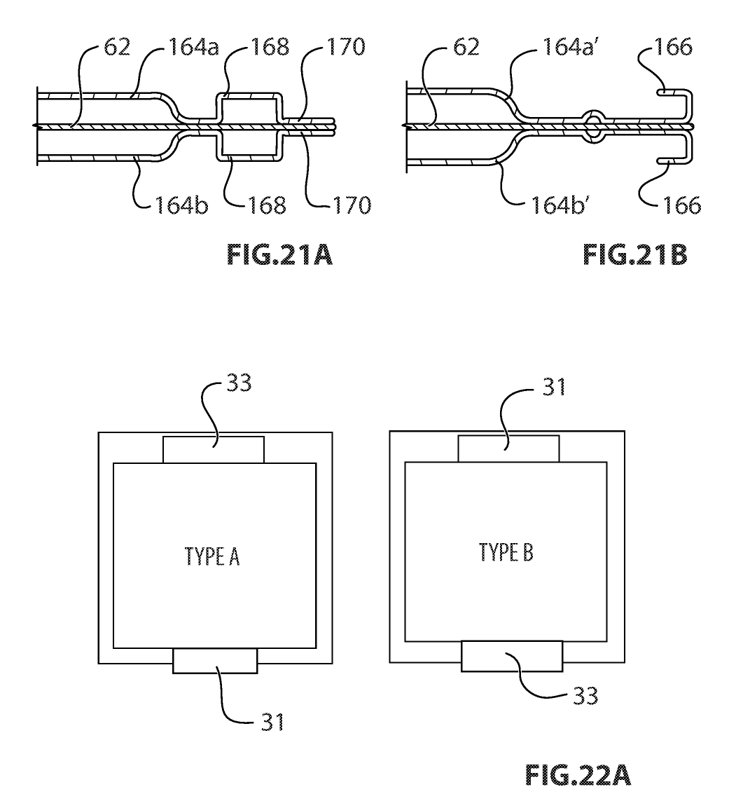

Similarly, the upper and lower clam shell halves of the battery casing may be modified at their periphery to introduce cooling fins and thus increase the radiating surface area without substantially increasing the overall breadth of the design. For example, FIG. 21A shows each of the upper and lower clam shell halves 164a, 164b having at their peripheries a rectangular channel 168 with a continuing fin 170. The rectangular channels 168 and fins 170 provide a tubular cooling structure with increased radiating area. FIG. 21B shows each of the upper and lower clam shell halves 164a′, 164b′ terminating in a hook-shaped edge 166 functioning as a cooling fin.

While particular embodiments of the invention have been described, it will be appreciated that other modifications and variations may be made to the detailed embodiment(s) described herein without departing from the spirit of the invention.

1. A battery, comprising:
at least one cathode sheet formed from a metallic foil electrode coated with an active material;
at least one anode sheet formed from a metallic foil electrode coated with an active material, the anode sheet being disposed in overlying relationship with the cathode sheet so at provide at least one cathode/anode electrode pair;
a separator between the cathode and anode sheets;
electrolyte;
a packaging encasing the at least one cathode and anode sheets and containing the electrolyte;
characterized in that at least the cathode active material is formed with ridges and depressions therein for enabling the electrolyte to flow and wet the electrode.

2. A battery according to claim 1, comprising:
a plurality of said cathode sheets;
a plurality of said anode sheets interleaved between the cathode sheets so as to provide a plurality of said cathode/anode electrode pairs;
said separator being interleaved between the cathode and anode sheets;
wherein said cathode/anode pairs are arranged in the form of a prismatic battery.

3. A battery according to claim 2, wherein the anode active material has ridges and depressions therein for enabling the electrolyte to wet the electrode.

4. A battery according to claim 2, wherein the metallic foils of each of the anode and cathode sheets have first and second faces that are both coated with active material.

5. A battery according to claim 4, wherein the ridges and depressions in the active material are formed by calendaring the coated metallic foil in order to compress various regions of the coating more than other regions.

6. A battery according to claim 4, wherein the ridges and depressions in the active material are formed by ablation of the coating in various regions.

7. A battery according to claim 4, wherein the ridges and depressions in the active material are formed by screening the coating via a mask onto certain regions of the foil but not other regions.

8. A prismatic battery, comprising:
a first stack of cathode/anode pairs;
a second stack of cathode/anode pairs;
wherein each cathode/anode pair comprises a flexible cathode sheet, a flexible anode sheet overlapping and co-extensive with the cathode sheet, and a separator interleaved between the cathode sheet and anode sheet;
a heat conducting plate having first and second faces, wherein the first stack abuts the first plate face and the second stack abuts the second plate face, the plate extending past a periphery of the first and second stacks to provide a heat dissipation surface;
a casing housing the first and second stacks and in thermal contact with the plate.

9. A battery according to claim 8, wherein a periphery of the casing incorporates a tubular structure for directing the flow of cooling medium and the plate projects into the tubular structure.

10. A battery according to claim 9, wherein the casing is composed of two clam shell halves, each clam shell half having a half-cylinder formed at a periphery thereof.

11. A battery according to claim 8, including a male snap fit terminal electrically connected to the first stack and a female snap fit terminal electrically connected to the second stack, the male and female snap fit connectors projecting from the casing on opposing sides of the plate.

12. A battery according to claim 8, wherein at least the cathode sheets have ridges and depressions therein enabling the electrolyte to flow and wet the cathode sheets.

13. A battery according to claim 12, wherein the anode sheets have ridges and depressions therein for enabling the electrolyte to wet the anode sheets.
